(19) United States
(12) Patent Application Publication
(10) Pub. No.: US 2026/0170315 A1
(43) Pub. Date: Jun. 18, 2026

(54) SPARSITY PACKING FOR WEIGHT TENSORS IN MACHINE LEARNING MODELS

(71) Applicant: Amazon Technologies, Inc., Seattle, WA (US)

(72) Inventors: Mahdi Heydari, Palo Alto, CA (US); Deepak Shivarudrappa, Fremont, CA (US); Nikhilesh Reddy Chichhili, Newark, CA (US); Sankalp Dayal, San Mateo, CA (US)

(21) Appl. No.: 18/978,573

(22) Filed: Dec. 12, 2024

(51) Int. Cl. G06N 3/0495

(52) U.S. Cl. CPC G06N 3/0495

(57) ABSTRACT

Devices and techniques are generally described for sparsity packing for weight tensors. A first weight tensor including a first plurality of elements may be determined. A first block of two or more elements may be determined, where the first block consists of zero-valued elements. The first block of two or more elements may be represented using a first bit value in a sparsity map. A second block of two or more elements may be determined, where the first block includes at least one non-zero element. The second block of two or more elements may be represented using a second bit value in the sparsity map. A compressed weight tensor that includes the second block of two or more elements and omits the first block of two or more elements may be generated. The compressed weight tensor and the sparsity map may be stored in a first memory.

### BACKGROUND

Machine learning techniques are used to form predictions, solve problems, recognize objects in image data for classification, etc. For example, machine learning techniques may be used to detect objects represented in image data, generate text, images, translate text from one human understandable language to another, etc. In various examples, machine learning models may be improved over time by retraining the models as more or different data becomes available. Accordingly, machine learning techniques are adaptive to changing conditions. Deep learning algorithms, such as neural networks, are sometimes used to detect patterns in data and/or perform tasks.

### BRIEF DESCRIPTION OF DRAWINGS

FIG. 1 is a block diagram of an example machine learning accelerator architecture that may include a sparsity-aware weight packing engine, according to various embodiments of the present disclosure.

FIG. 2A depicts an example of sparsity-aware weight packing using a conventional technique, for illustrative purposes.

FIGS. 2B-2C depict examples of sparsity-aware weight packing using a reduced-size sparsity map, according to various aspects of the present disclosure.

FIG. 3 depicts an unpacking example where an expanded sparsity map is generated from the reduced-size sparsity map of FIG. 2B, in accordance with various examples of the present disclosure.

FIG. 4 depicts an example process for sparsity packing for weight tensors of machine learning models, in accordance with various aspects of the present disclosure.

FIG. 5 is a block diagram showing an example architecture of a network-connected device that may be used in accordance with various aspects described herein.

FIG. 6 is a block diagram showing an example architecture of computing devices that may be used in accordance with various aspects described herein.

### DETAILED DESCRIPTION

In the following description, reference is made to the accompanying drawings that illustrate several examples of the present invention. It is understood that other examples may be utilized and various operational changes may be made without departing from the scope of the present disclosure. The following detailed description is not to be taken in a limiting sense, and the scope of the embodiments of the present invention is defined only by the claims of the issued patent.

Artificial intelligence systems including various machine learning models are currently being developed and deployed for a wide variety of use cases, including generative models such as language models (e.g., large language models (LLMs)), image/video generation models (e.g., latent diffusion models), computer vision models, LLM-based agents, neural network-based classifiers, etc. Such machine learning models can be executed on general purpose processors and/or hardware accelerators using program code written in a specialized programming language such as TensorFlow, PyTorch, etc. The program code is converted into machine instructions by a compiler. In a neural network, the types of computations performed, and the data the computations are performed on, can be different from computations used for other things. For example, neural networks can involve repeated manipulation of large quantities of data representing tensors. The term tensor will sometimes be used herein in accord with its mathematical meaning, but will also sometimes be used herein to refer to stored data representing a tensor or a data structure storing data representing a tensor, e.g. a vector, matrix, or larger dimensional data structure. The term channel will sometimes be used herein to refer to a mathematically defined portion of a tensor, e.g. for a three dimensional tensor characterized as having rows, columns, and sheets (the term sheet is used here instead of the sometimes used term “channel” to avoid confusion), the term channel may refer to a row of a single sheet, a row of all sheets, a column of a single sheet, or a column of all sheets.

As used herein, a data structure storing weight values for a particular layer of a machine learning model may sometimes be referred to as a weight tensor. Output from a previous operation may be used with a weight tensor for a current layer (e.g., effecting matrix multiplication) to generate another tensor. An activation function may then be used with another tensor to generate an activation tensor. This activation tensor may then subsequently be used together with another weight tensor, or other intermediate operations may first be performed. Weight values (and bias values) are examples of the learnable parameters of machine learning models. As used herein, weight values include both model weights and bias values.

The sparsity of weight tensors (e.g., the number of zero-valued elements in a weight tensor) may be exploited to reduce the computational load, reduce latency, reduce power consumption, increase throughput, etc. For example, a weight tensor may be compressed to remove zero-valued elements thereby generating a compressed weigh tensor that requires less memory to store and which consumes less memory bandwidth when loaded into SRAM for compute. However, in order to know the corresponding activation values pertinent to a given element of a weight tensor, a sparsity map may also be generated. A sparsity map typically uses a single bit for each element of the uncompressed weight tensor, with each bit representing whether the corresponding element of the uncompressed weight tensor is a zero-valued element or a non-zero-valued element. Accordingly, the sparsity map may be used together with the compressed weight tensor to determine the appropriate values of an activation tensor needed during compute (e.g., to compute the activation tensor for a given layer of a neural network). Such compression techniques can be quite beneficial, particularly for larger machine learning models such as many language models (e.g., large language models (LLMs)) which can have a huge number of parameters (thus consuming a large amount of storage and affecting latency and memory bandwidth as such parameters are loaded from storage into SRAM for compute).

As described in further detail below in reference to the figures, conventional approaches use sparsity maps that require 1 bit for each element of the uncompressed version of the original weight tensor. However, improved compression techniques described herein enabled added compression for sparsity maps, reducing the overall compression overhead by more than 50%. The additional compression results in reduced memory footprint, conservation of memory bandwidth, reduced power consumption, and inference processing speedup for LLMs by more than 30%. The various techniques described herein are particularly important for current and future classes of large models (e.g., machine learning models having billions or trillions of parameters) with performance that is currently both compute and memory bound.

The various machine learning models described herein may be executed on a combination of physical and/or virtualized computing devices/resources. Physical computing resources may include, for example, hardware compute processing units (CPUs), hardware accelerators (e.g., graphics processing units (GPUs), neural processing units (NPUs), neural network accelerators (NNAs), physical memory, etc. Examples of virtualized computing resources may include virtualized CPUs, GPUs, NNAs, virtual memory, etc. Computing resources may include virtualized components executing on physical hardware. In some examples, the virtualized components and/or the physical hardware on which the virtualized components are executed may be distributed (e.g., geographically diverse). A collection of distributed compute services (e.g., of a given server instance) may be instantiated, for example, using a container orchestration framework, one or more virtual machines, physical hardware, etc. In some other examples, a given server instance may executed on the same hardware components (and may not be distributed). Accordingly, server instances may include components that are physical and/or virtual and which may be distributed and/or co-located. A configuration for a given server instance can refer to the different hardware (whether physical or virtualized) deployed on the server instance, the software deployed on the server instance, and/or the configurations thereof.

In various examples discussed herein, some of the computing devices described herein may be provisioned with and/or may employ accelerator hardware. In some cases, machine learning accelerators (and/or general processors, depending on the implementation) may be programmed to implement an inference engine. An inference engine (or “compute engine”) refers to programming a machine learning accelerator and/or general purpose processor (or processors) to execute the various operations of a particular machine learning model. Examples of such operations may include determining dot products of two vectors, vector addition, vector multiplication, matrix multiplication, forward and backward convolutions, pooling, etc. Inference engines may be implemented using machine learning accelerator hardware and/or other specialized processors (e.g., graphical processing units, tensor processing units).

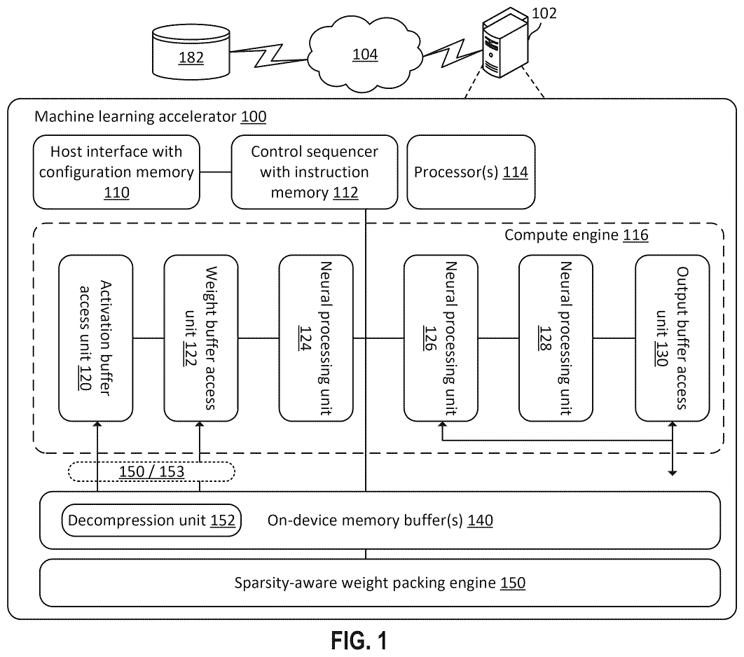

Hardware accelerators may include a class of specialized hardware accelerators designed to accelerate machine learning applications by focusing on arithmetic operations and in-memory computing capability. A neural network accelerator (NNA) architecture is an example of a machine learning accelerator hardware that has been designed to accelerate processing for neural networks. An example of a NNA is described below in reference to FIG. 1. A variety of different operations may be performed by a particular machine learning model during inference. As an example of machine learning operations (e.g., operations that may be optimized to improve performance using the various hardware and/or techniques described herein), a forward pass of a feed forward neural network is now described.

The forward pass involves a series of mathematical transformations that start at the input layer, propagate through one or more hidden layers, and culminate in the output layer. Input data, usually in the form of vectors (e.g., a numerical encoding of one or more inputs token representing words or sub-words, in the context of language models), is provided to the input layer of the model. In a fully-connected example, each neuron of the input layer is connected to each neuron of the subsequent first hidden layer. For each neuron of the input layer, the value is multiplied by a respective weight (a parameter learned during training). The weight value for a given input neuron is specific to that neuron's connection with a given neuron in the first hidden layer. For a given neuron in the first hidden layer, the weighted inputs are summed together and a bias term is added. The bias term allows the activation function to be shifted to the left or right (e.g., to be more negative or more positive). This summation result may be passed through an activation function (e.g., sigmoid, a rectified linear units (ReLu) function, tanh, etc.) to introduce non-linearity into the model. The resulting value is the activation value for the first neuron in the first hidden layer. This process is repeated for each neuron in the first hidden layer. Note that the weight values connecting nodes in the input layer may be different for each distinct neuron in the first hidden layer (and similarly for the connections between subsequent hidden layers and the output layer). The activation values for the neurons at the first hidden layer (and similarly for any hidden layer and the output layer) may be stored together in a data structure referred to herein as an activation tensor. In an activation tensor, each element may correspond to a neuron and the value of that element may be the current activation value for that neuron (generated for the current input). Since the inputs may be dynamic, these activation values change over time. In contrast, the weight values, which may be conceptually thought of as the values of the connections between neurons, are static (post training) until the model is re-trained, and are thus of static sparsity. However, as described in further detail below, some level of sparsity can be enforced in weight tensors during training. In some examples, described herein, training may enforce blocks of any number of consecutive tensor elements (e.g., pairs, triples, etc.) to be zero-valued elements in order to enhance the improved compression techniques discussed herein. It should be noted that “blocks” of elements, as used herein, may be of any desired dimensionality and/or shape. For example, a 1×2 block may refer to two consecutive elements in a single row (e.g., 1 row by 2 columns), while a 1×3 block may refer to three consecutive elements in a single row. In another example, a 2×2 block may refer to a square block of elements (2 rows by 2 columns of consecutive elements). Blocks may be three dimensional (e.g., m×n×p in a 3D weight tensor) and/or of other shapes (e.g., a 2×3 block of elements in a matrix). Consecutive elements in a given block may refer to any elements that are directly adjacent to one another (along any dimension of the tensor) without any intervening elements.

Some current LLM architectures include over a trillion learnable parameters. As such loading all of these parameters into random access memory (RAM) during processing involves loading a large amount of data into memory and involves a large number of multiplication and addition operations. The various sparsity-aware weight packing techniques described herein may dynamically reduce the size of weight tensors that are required to be loaded into memory for a given input and may also reduce the required number of arithmetic operations being performed leading to huge improvements in memory footprint, compute, throughput, and power consumption.

Machine learning techniques, such as those described herein, can be used to form predictions, solve problems, answer questions, recognize objects in image data for classification, generate images, video, and/or natural language data, etc. In various examples, machine learning models may perform better than rule-based systems and may be more adaptable as machine learning models may be improved over time by retraining the models as more and more data becomes available. Accordingly, machine learning techniques can adapt to changing conditions.

Generally, in machine learning models, such as neural networks, after initialization, annotated training data may be used to generate a differentiable cost or “loss” function that describes the difference between expected output of the machine learning model and actual output. The parameters (e.g., weights and/or biases) of the machine learning model may be updated to minimize (or maximize) the cost. For example, the machine learning model may use a gradient descent (or ascent) algorithm to incrementally adjust the weights to cause the most rapid decrease (or increase) to the output of the loss function. The method of updating the parameters of the machine learning model is sometimes referred to herein as back propagation.

As previously described, the compute cost (in terms of compute resources used) for a given inference request may vary greatly depending on the complexity of the request and the particular machine learning model being deployed. Some examples of machine learning architectures which may be deployed for inference processing are now described. It should be noted that these examples do not constitute an exhaustive list and that the inference routing and/or complexity classification techniques described herein may be used with any desired machine learning model architectures.

### Language Models

A generative LM is an artificial intelligence (AI) model that may be capable of processing and generating human-like text based on the latent information it has learned from vast amounts of training data. In some cases, some LMs are referred to as “large” language models (LLMs). The term “large” refers to the size of these models in terms of the number of parameters or weights, which are the values that the model learns during training to make predictions and/or generate output such as text, synthesized speech, control instructions for control of other devices, etc. LMs may have millions, billions (or even more) parameters, which enable such models to capture complex patterns and nuances in language that, in turn, allow the models to process and generate more natural-sounding text (relative to previous approaches). LMs are typically trained on massive datasets that include a wide variety of text from various sources, enabling the LMs to “understand” grammar, context, and the relationships between words, sentences, paragraphs, etc. Examples of LMs include the generative pre-trained transformer models (e.g., GPT-3, GPT-4), Pathways Language Model (PaLM), Large Language Model Meta Artificial Intelligence (LLaMA), Claude by Antrhopic, as well as non-generative examples such as BERT (bidirectional encoder representations from Transformers), etc.

In a generative context, an LM may generate text that is responsive to the input prompt provided to the LM. LMs excel at generating natural sounding text that appears as though it has been generated by a native speaker in the relevant language. In addition to fluency, generative LMs are able to generate detailed, relevant, and largely accurate responses to input prompts in many cases due to the large amount of latent information the generative LM has learned during training. The term “prompt” may refer to plain text or structured text, and may be provided via an interface to the LM, such as an API. The prompt may generally be written in natural language, expressed, for example, as if requesting a task to be performed by the LM (e.g., “Who is the current President of the United States?”). In some examples, contextual information may be provided (e.g., as part of the prompt) and/or may be retrieved (e.g., from external sources) by the LM (e.g., retrieval-augmented generation (RAG)) and used to respond to the prompt). In some examples, LMs may be instructed (e.g., using hidden prompts) as to how to use various external APIs and/or tools (e.g., online search engines and/or other software) that may, in turn, be used to perform actions responsive to user-input requests. LMs are often built using the transformer architecture, which is described in further detail below. It should be noted, however, that transformers may be used in other machine learning contexts beyond LMs.

### Transformer Models

Transformer models are employed in many different types of machine learning architectures, including many of the LMs previously described. Transformer models are machine learning models that include an encoder network and a decoder network. The encoder takes an input (e.g., a “prompt”) and generates feature representations (e.g., feature vectors, feature maps, etc.) of the input. The feature representation is then fed into a decoder that may generate an output based on the encodings. In natural language processing, transformer models take sequences of words as input. A transformer may receive a sentence and/or a paragraph (or any other quantum of text) comprising a sequence of words as an input.

The encoder network of a transformer comprises a set of encoding layers that processes the input data one layer after another. Each encoder layer generates encodings (referred to herein as “tokens”). These tokens include feature representations (e.g., feature vectors and/or maps) that include information about which parts of the input data are relevant to each other. Each encoder layer passes its token output to the next encoder layer. The decoder network takes the tokens output by the encoder network and processes them using the encoded contextual information to generate an output (e.g., the aforementioned one-dimensional vector of tokens). The output data may be used to perform task-specific functions and/or generate a natural language response to the input (depending on the specific model being employed). To encode contextual information from other inputs (e.g., combined feature representation), each encoder and decoder layer of a transformer uses an attention mechanism, which for each input, weighs the relevance of every other input and draws information from the other inputs to generate the output. Each decoder layer also has an additional attention mechanism which draws information from the outputs of previous decoders, prior to the decoder layer determining information from the encodings. Both the encoder and decoder layers have a feed-forward neural network for additional processing of the outputs, and contain residual connections and layer normalization steps.

### Scaled Dot-Product Attention

The basic building blocks of the transformer are scaled dot-product attention units. When input data is passed into a transformer model, attention weights are calculated between every token simultaneously. The attention unit produces embeddings for every token in context that contain information not only about the token itself, but also a weighted combination of other relevant tokens weighted by the attention weights.

Concretely, for each attention unit the transformer model learns three weight matrices; the query weights W_{Q}, the key weights W_{K}, and the value weights W_{V}. For each token i, the input embedding xᵢ is multiplied with each of the three weight matrices to produce a query vector qᵢ=xᵢ W_{Q}, a key vector kᵢ=xᵢ W_{K}, and a value vector vᵢ=xᵢ W_{V}. Attention weights are calculated using the query and key vectors: the attention weight aᵢⱼ from token i to token j is the dot product between qᵢ and kⱼ. The attention weights are divided by the square root of the dimension of the key vectors, \sqrt{dₖ}, which stabilizes gradients during training. The attention weights are then passed through a softmax layer that normalizes the weights to sum to 1. The fact that W_{Q} and W_{K} are different matrices allows attention to be non-symmetric: if token i attends to token j, this does not necessarily mean that token j will attend to token i. The output of the attention unit for token i is the weighted sum of the value vectors of all tokens, weighted by dij, the attention from i to each token.

The attention calculation for all tokens can be expressed as one large matrix calculation, which is useful for training due to computational matrix operation optimizations which make matrix operations fast to compute. The matrices Q, K, and V are defined as the matrices where the ith rows are vectors qᵢ, kᵢ, and vᵢ respectively.

$$Attention ( Q , K , V ) = softmax ( \frac{Q {K}^{T}}{\sqrt{{d}_{k}}} ) V$$

### Multi-Head Attention

One set of (W_{Q}, W_{K}, W_{V}) matrices is referred to herein as an attention head, and each layer in a transformer model has multiple attention heads. While one attention head attends to the tokens that are relevant to each token, with multiple attention heads the model can learn to do this for different definitions of “relevance.” The relevance encoded by transformers can be interpretable by humans. For example, in the natural language context, there are attention heads that, for every token, attend mostly to the next word, or attention heads that mainly attend from verbs to their direct objects. Since transformer models have multiple attention heads, they have the possibility of capturing many levels and types of relevance relations, from surface-level to semantic. The multiple outputs for the multi-head attention layer are concatenated to pass into the feed-forward neural network layers.

Each encoder comprises two major components: a self-attention mechanism and a feed-forward neural network. The self-attention mechanism takes in a set of input encodings from the previous encoder and weighs their relevance to each other to generate a set of output encodings. The feed-forward neural network then further processes each output encoding individually. These output encodings are finally passed to the next encoder as its input, as well as the decoders.

The first encoder takes position information and embeddings of the input data as its input, rather than encodings. The position information is used by the transformer to make use of the order of the input data. In various examples described herein, the position embedding may describe an order of a sequence of words.

Each decoder layer comprises three components: a self-attention mechanism (e.g., scaled dot product attention), an attention mechanism over the encodings, and a feed-forward neural network. The decoder functions in a similar fashion to the encoder, but an additional attention mechanism is inserted which instead draws relevant information from the encodings generated by the encoders. In a self-attention layer, the keys, values and queries come from the same place—in the case of the encoder, the output of the previous layer in the encoder. Each position in the encoder can attend to all positions in the previous layer of the encoder. In “encoder-decoder attention” layers (sometimes referred to as “cross-attention”), the queries come from the previous decoder layer, and the keys and values come from the output of the encoder. This allows every position in the decoder to attend over all positions in the input sequence. The decoder is attending to the encoder features.

The foregoing examples of machine learning processing tasks are merely examples to show the diversity (in terms of both the task and the complexity) of machine learning techniques. However, the sparse activation aware hardware and techniques described herein may be used with any machine learning tasks.

FIG. 1 is a block diagram of an example machine learning accelerator 100 that may include a sparsity-aware weight packing engine 150, according to various embodiments of the present disclosure. In various examples, one or more computing devices 102 may include and/or be used to execute the machine learning accelerator 100 and/or components thereof. Additionally, the various components of the one or more computing devices 102 implementing machine learning accelerator 100 may be a collection of compute services that are distributed in a cloud-based environment. The components of machine learning accelerator 100 may communicate with one another and/or with remote computing devices (such as the various server instances discussed herein) via a network 104. Network 104 may be a wide area network, such as the Internet, an intranet, a local area network (LAN), and/or some combination thereof. Non-transitory computer-readable memory 182 may store instructions that, when executed by one or more processors of the one or more computing devices 102 may be effective to instantiate the various components of machine learning accelerator 100 and/or perform the various techniques described herein. In various examples, the memory 182 may be system memory comprising one or more persistent data stores that may store the weight tensors of one or more trained machine learning models including the compressed weight tensors and compressed sparsity maps described herein. For example, the memory 182 may store weight tensors for an LLM being executing using, at least in part, the machine learning accelerator 100.

The machine learning accelerator 100 is one example instantiation of a hardware accelerator that may be used to perform highly-parallelized computations that may be typical of machine learning inference, training, and/or testing (e.g., matrix multiplication, tensor products, etc.). However, it should be noted that other types of accelerator hardware may also be used (and/or may be used in combination with the machine learning accelerator 100) in accordance with the present disclosure. For example, graphics processing units (GPUs), tensor processing units (TPUs), field-programmable gate arrays (FPGAs), neural processing units (NPUs), application-specific integrated circuits (ASICs), inference accelerators, etc., may be used in various server instance configurations described herein.

The machine learning accelerator 100 (e.g., a neural network accelerator, GPU, etc.) comprises a host interface 110, a control sequencer 112, an optional processor 114 (e.g., one or more CPUs with any number of cores), an activation buffer access unit 120, a weight buffer access unit 122, a plurality of neural processing units (NPUs) 124, 126, and 128, an output buffer access unit 130, a set of on-device memory buffers 140, and a sparsity-aware weight packing engine 150. The activation buffer access unit 120, the weight buffer access unit 122, the NPUs 124, 126, and 128, and the output buffer access unit 130 collectively form a compute engine 116. Along with the control sequencer 112 and the sparsity-aware weight packing engine 150, the compute engine 116 is responsible for executing instructions. Although a neural network accelerator (machine learning accelerator 100) is shown and described in the examples of FIG. 1, the sparsity-aware weight packing, unpacking, and inference optimization techniques described herein may be used with any machine learning hardware accelerator and/or with a general purpose processor (e.g., using software).

The machine learning accelerator 100 can be implemented as a standalone computing system or, as shown in FIG. 1, as part of a computing system comprising a host processor and system memory 182. The machine learning accelerator 100 depicted in FIG. 1 is merely an example and is not intended to unduly limit the scope of claimed embodiments. One of ordinary skill in the art would recognize many possible variations, alternatives, and modifications. For example, in some implementations, machine learning accelerator 100 may have more or fewer components than those shown in FIG. 1, may combine two or more components, or may have a different configuration or arrangement of components. The machine learning accelerator 100 generally executes one set of instructions at a time. This set of instructions is referred to herein as a “context.” At runtime, the machine learning accelerator 100 sequences and dispatches, using control sequencer 112, instructions from a pre-compiled context for execution. In certain embodiments, each context comprises a set of instructions that ends with a HALT instruction. Contexts are created by a software compiler. The instructions within a context can implement at least part of a neural network. For example, a context can correspond to a complete layer, a partial layer, or multiple layers of the neural network. In some instances, a context can correspond to a complete neural network (e.g., with instructions for an input layer, a hidden layer, and an output layer).

The host interface 110 is a communication interface to the host processor (not depicted) of the computing system. The computing system includes system memory for storing data operated on by the NNA (e.g., weights, activations, and output values corresponding to inferences). The machine learning accelerator 100 may be communicatively coupled to multiple hosts simultaneously, with any one of the hosts being able to program the machine learning accelerator 100 to execute neural network-related tasks on behalf of the host. The host interface 110 can communicate with the host processor via a standard communication protocol such as, for example, Advanced extensible Interface (AXI) protocol. Similarly, the machine learning accelerator 100 can include a separate communication interface for communicating with the system memory, e.g., to read and write data from the on-device memory buffers 140 to the system memory 182. The communication interface to the system memory 182 is, in certain embodiments, integrated into the sparsity-aware weight packing engine 150. Thus, the sparsity-aware weight packing engine 150 can also include an AXI interface.

The control sequencer 112 is responsible for sequencing, dispatching, and finishing execution of instructions. Some instructions are executed entirely in the control sequencer 112. Other instructions may be dispatched to one or more of the NPUs 124, 126, and 128 for execution, possibly with execution results being returned to the control sequencer 112 for further processing. Still other instructions are executed by the sparsity-aware weight packing engine 150 to move data to and from the on-device memory buffers 140 (e.g., DRAM). More than one instruction can be in the execution phase at any given time within the machine learning accelerator 100. The control sequencer 112 can include an instruction memory into which instructions to be executed by the machine learning accelerator 100 are downloaded from the host processor or loaded from the system memory. In the example of FIG. 1, the host interface 110 includes a configuration memory. The configuration memory may include one or more registers that are configurable by the host processor to specify parameters relating to the context to be executed, e.g., various context dependent parameter registers (CDPRs).

In certain embodiments, the configuration memory includes a predicate register for synchronizing execution of instructions. Instructions are broadcast by the control sequencer 112 to each component of the compute engine 116 as well as the on-device memory buffers 140 and the sparsity-aware weight packing engine 150. Upon receipt of a broadcast instruction, a component may proceed to execute at least part of the instruction in response to determining that the component is capable of handling the instruction. For example, the sparsity-aware weight packing engine 150 could receive and execute a data move instruction, but the NPUs 124, 126, and 128 could ignore the data move instruction. Because instructions can execute concurrently in different components, it is useful to have a synchronization mechanism to handle any dependencies between instructions. The predicate register can be used to implement such a synchronization mechanism and, in certain embodiments, is a global register visible to internal components of the machine learning accelerator 100, as well as visible to external entities such as the host processor. Synchronization also helps to prevent conflicts in accessing the on-device memory buffers 140.

The processor 114 is an optional general purpose processor for performing certain types of processing in parallel with processing performed by the NPUs 124, 126, and 128. For example, processor 114 may include a floating point unit or other arithmetic logic unit for performing general arithmetic operations in parallel with matrix operations performed by the NPUs 124, 126, and 128.

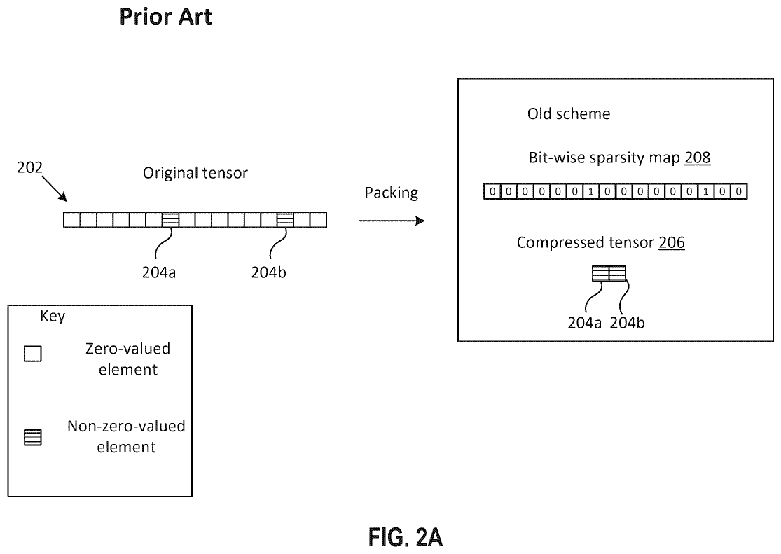

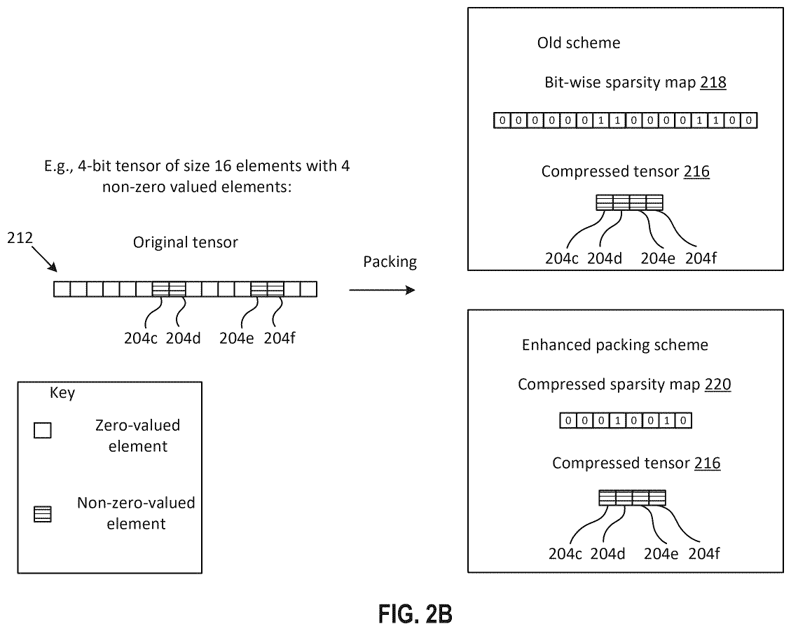

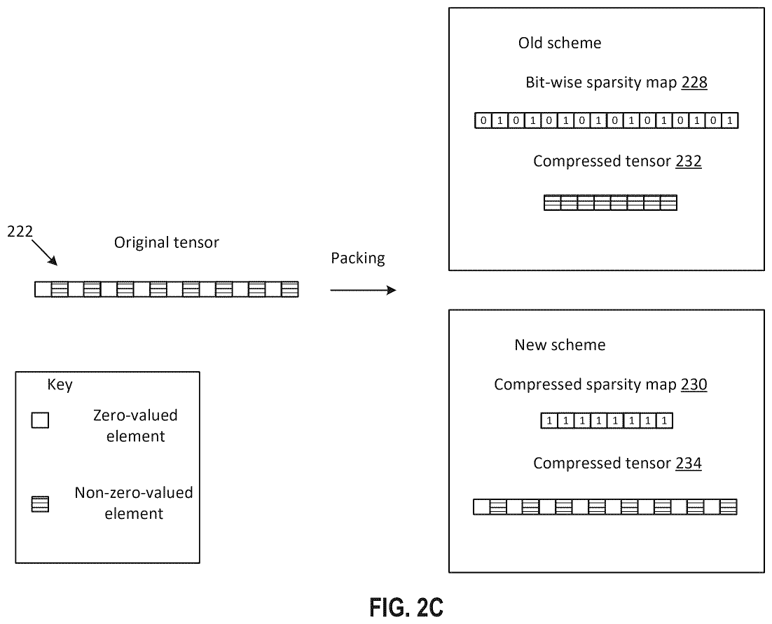

The activation buffer access unit 120 is configured to access one or more activation buffers in the on-device memory buffers 140 (e.g., SRAM). The sparsity-aware weight packing engine 150 may compress weight tensors (e.g., post training quantization) by exploiting the sparsity of the weight tensors as described below in reference to FIGS. 2A-2C. Additionally, the sparsity-aware weight packing engine 150 may generate a sparsity map for each compressed weight tensor (e.g., using the efficient sparsity map generation techniques described below in reference to FIGS. 2B and 2C). A sparsity map may be used to determine the positions of zero-valued elements and non-zero-valued elements of the weight tensor so that the correct activation values may be multiplied by the non-zero valued weight tensor elements.

Similarly, the weight buffer access unit 122 and the output buffer access unit 130 are configured to access one or more weight buffers and one or more output buffers, respectively. The activations stored in the activation buffer(s) correspond to activations produced by one or more layers of a neural network being executed on the machine learning accelerator 100. The weights stored in the weight buffer(s) are synaptic weights (e.g., model parameters) associated with edges between a node of one layer and a node of another layer. Activation and weights are used for certain computations, including for instructions executed by the compute engine 116. The output buffers can store final results or intermediate results (e.g., partial sums) for access by the host processor or the system memory 182. The NPUs 124, 126, and 128 perform numerical operations using the activations and weights stored in the on-device memory buffers 140. Each NPU is configured to perform all or part of a compute instruction. Although FIG. 1 depicts the NPUs 124, 126, and 128 as block components, the NPUs 124, 126, and 128 are not necessarily identical. For example, the operations of one NPU may differ from the operations performed by another NPU.

The sparsity-aware weight packing engine 150 may be used to bidirectionally move instructions and data between the system memory and NNA on-device memories (e.g., the activation, the weight, and output buffers that form the on-device memory buffers 140). The sparsity-aware weight packing engine 150 can receive data move instructions (e.g., LOAD and STORE instructions) from the control sequencer 112 when such instructions are broadcast. The data move instructions executed by sparsity-aware weight packing engine 150 can execute concurrently with compute instructions executed by the control sequencer 112 or the compute engine 116. As described herein, the sparsity-aware weight packing engine 150 may use sparsity maps to determine the appropriate activation tensor elements that should be multiplied by the compressed weight tensors (and thereby reduce the number of required operations that are needed to be processed).

As shown in FIG. 1, a decompression unit 152 in the on-device memory buffer(s) 140 may be used to unpack the compressed sparsity maps to generate expanded sparsity maps. These expanded sparsity maps may be used to identify the elements of the compressed weight tensor and/or the corresponding elements of the activation tensor, for compressed tensor multiplication.

Quantization aware training may compress weight values (and/or other stored data of a model) into smaller representations. In various examples, the weights from system memory 182 may be decompressed into a format (e.g., 8-bit integer (“INT8”)) that is compatible with the neural network accelerator 100. In various examples, the location of the decompression unit 152 can vary. For example, in another embodiment, the decompression unit 152 (e.g., “in-line” decompression) can be part of the compute engine 116 and is configured to decompress/unpack data stored in the on-device memory buffers 140 for input of the decompressed data to one or more of the NPUs 124, 126, and 128. Optionally, on-the-fly decompression may be used (e.g., by optional decompression unit 153) to decompress/unpack weight values in on-device memory buffer(s) 140 when loading weight values into weight buffer access unit 122. Additionally, in some examples, the sparsity-aware weight packing engine 150 may generate compressed versions of the activation tensors (e.g., by removing zero-valued elements or channels) and may load only the channels of the weight tensors that correspond to non-zero activation channels. These compressed versions may be directly acted upon by the NPUs 124, 126, 128, etc., in order to reduce the number of required computations.

The decompression unit 152 implements a decompression pipeline. The decompression pipeline of the decompression unit 152 involves processing using one or more decompression schemes. The decompression unit 152 can select between using one decompression scheme alone or using multiple decompression schemes in combination. For example, the decompression unit 152 may decompress data using zero value decompression and then further decompress the data using shared value decompression. In the example of zero value plus shared value decompression, the order in which the compression schemes are applied can vary depending on how the decompression unit 152 is implemented. Thus, zero value decompression could be performed first followed by shared value decompression. Alternatively, shared value decompression could be performed first. In general, the order in which zero value decompression and shared value decompression are performed does not matter as the resulting decompressed data would be the same irrespective of which decompression scheme is applied first. Decompression unit 152 may also perform the sparsity map unpacking techniques described herein to generate expanded sparsity maps in the on-device memory buffer(s) 140.

In the example of FIG. 1, the decompression unit 152 may be configured to receive compressed data from the system memory 182 and decompress the compressed data, using one or more decompression schemes, to generate decompressed data for storage in the on-device memory buffers. Alternatively, in certain embodiments, the decompression unit 152 may be configured to receive compressed data from the on-device memory buffers and decompress the compressed data for use by a processing component of the machine learning accelerator 100 (e.g., one of the NPUs 124, 126, and 128, or the control sequencer 112). Thus, the data may be stored in either compressed or decompress form within the on-device memory buffers 140. Irrespective of how the data is stored in the on-device memory buffers 140, the data may be sent from the system memory to the machine learning accelerator 100 in compressed form. Sending the data to the NNA in compressed form reduces the amount of time required to send the data.

The on-device memory buffers 140 are used to abstract the physical implementation of memories that form the activation, weight, and output buffers from NNA components (e.g., the compute engine 116 and the sparsity-aware weight packing engine 150) that access data in these buffers. The data in the activation, weight, and output buffers is accessed through addressing the buffers individually, with the buffer addresses being mapped to the physical addresses of the memories where the data is stored. In certain embodiments, the memories of the on-device memory buffers 140 are implemented as static random-access memory (SRAM) devices. However, the on-device memory buffers 140 can be implemented using other types of memory, both volatile and non-volatile (e.g., flash memory, DRAM, resistive RAMs, and the like). As mentioned above, the data in be stored in the on-device memory buffers 140 in compressed or decompressed form.

The NPUs 124, 126, and 128 perform numerical arithmetic operations using the activations and weights stored in the on-device memory buffers 140. Each NPU is configured to perform all or part of a compute instruction. The compute instruction may, for example, implement at least some of the computation described earlier in connection with processing by a node of a neural network, i.e., computing a weighted sum of input activations multiplied by weights, adding a bias value to the weighted sum, and then applying an activation function. Other types of computations may also be performed by the NPUs 124, 126, and 128. For example, identifying the minimum and maximum values among a first set of data values represented by a first vector and a second set of data values represented by a second vector, performing an extended multiply add, subtracting two vectors, and other types of operations applicable to data from a vector or matrix may be performed.

FIG. 2A depicts an example of sparsity-aware weight packing using a conventional technique, for illustrative purposes. The original weight tensor 202 (e.g., uncompressed) is a sixteen element vector where only two elements, 204a and 204b, are non-zero-valued elements. Accordingly, a compressed tensor 206 may be generated that removes all zero-valued elements such that only the seventh and fourteenth elements (e.g., elements 204a and 204b, each having a non-zero value) of the original weight tensor 202 are represented in the compressed tensor 206.

However, since the dimensionality of the compressed tensor 206 is changed relative to the original tensor 202, without some mapping, there may be no way to determine which activation value (e.g., which neuron) corresponds to the elements 204a and 204b. Accordingly, a bit-wise sparsity map 208 (sometimes referred to as a compression map or “CMAP”) may be generated to represent the respective positions of the zero-valued-elements and the non-zero-valued elements in the original weight tensor 202.

In the example of FIG. 2A, let it be assumed that the original weight tensor 202 size (e.g., number of elements) is 16 and that each value of the original weight tensor 202 is represented using Int8. Accordingly, in this example, the original weight tensor 202 takes 16 bytes of memory (16 elements*1 byte/element). If using the sparsity-based compression scheme depicted in FIG. 2A, the bit-wise sparsity map 208 and the compressed tensor 206 together take 4 bytes of memory (representing a 75% memory reduction). The compressed memory value 4 bytes is given by:

$$2 non - zero elements ( each being 1 byte due to Int 8 representation ) + \frac{16 bits}{8 bits / byte} = 4 bytes .$$

For example, the 16 element bit wise sparsity map 208 takes 16 bits.

If the weights are instead preserved in 4 bits, then the memory requirement is 2*4/8+16/8=3 bytes (vs. 8 bytes originally) for a 62.5% memory reduction. The compressed memory value 3 bytes is given by:

$$2 non - zero elements ( each being 1 / 2 byte due to Int 4 representation ) + \frac{16 bits}{8 bits / byte} = 3 bytes .$$

Thus, the sparsity compression benefits are less for lower precisions and the sparsity map overhead is more significant. Described herein are enhanced sparsity-packing compression techniques that may be used to reduce the sparsity map (e.g., CMAP) overhead by more than 50%, providing enhanced memory footprint reduction and inference speedup.

FIGS. 2B-2C depict examples of sparsity-aware weight packing using a reduced-size sparsity map, according to various aspects of the present disclosure. In FIG. 2B, an original weight tensor 212 includes four non-zero-valued elements 204c, 204d, 204e, and 204f. Using the traditional sparsity packing scheme (e.g., the scheme of FIG. 2A), a 16 bit sparsity map (e.g., bit-wise sparsity map 218) is generated with 1-bit values in the elements that correspond to the four non-zero-valued elements 204c, 204d, 204e, and 204f in the original weight tensor 212. The compressed tensor 216 represents the values of only the four non-zero-valued elements 204c, 204d, 204e, and 204f. Accordingly, if the weight values are represented in Int8, the memory required for bit-wise sparsity map 218 and the compressed tensor 216 is 6 bytes (4 bytes for the compressed tensor 216 and 2 bytes (16 bits/8 bits/byte) for the bit-wise sparsity map 218.

However, using the enhanced packing scheme, every block of two elements of the original weight tensor 212 is represented using only a single bit in the compressed sparsity map 220. If a block includes only zero-valued elements the block is represented in the compressed sparsity map 220 using a 0 (although it should be noted that block with only zero-valued elements could instead be represented with a 1). Conversely, if the block includes any non-zero-valued elements, the block is represented with a 1 (similarly, this implementation could be flipped and non-zero-valued blocks could instead be represented with a 0, if desired). Accordingly, using the enhanced packing scheme, every two elements of the original weight tensor 212 are represented using only a single bit, resulting in a reduction in the size of the compressed sparsity map 220 (relative to bit-wise sparsity maps using conventional compression techniques (such as bit-wise sparsity map 218)). Indeed, compressed sparsity map 220 takes only 8 bits, while bit-wise sparsity map 218 takes 16 bits. If the weight values are represented in Int8, the memory required for compressed sparsity map 220 and the compressed tensor 216 is 5 bytes (4 bytes for the compressed tensor 216 and 1 byte (8 bits/8 bits/byte) for the compressed sparsity map 220. As such, a 16.67% memory reduction (5 bytes vs. 6 bytes) is seen for the enhanced packing scheme vs, the old scheme in FIG. 2B. If Int4 is used to represent the weights, the memory reduction is larger (i.e., 25% reduction at 4 bytes for the old scheme vs. 3 bytes for the enhanced packing scheme).

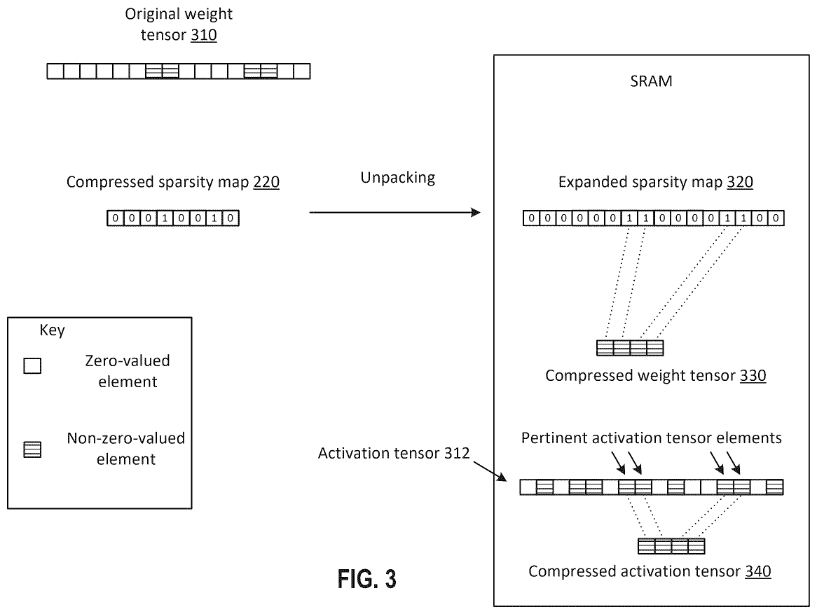

In either case, the compressed tensor 216 may be the same four non-zero-valued elements 204c, 204d, 204e, and 304f from the original weight tensor 212. Unpacking of the compressed sparsity map 220 to generate the expanded sparsity map 320 (e.g., for compute) is described in reference to FIG. 3. The compressed tensor 216 may be stored in system memory (e.g., memory 182) together with the compressed sparsity map 220 and may be loaded into the on-device memory buffer(s) 140 (e.g., SRAM) when needed for compute.

While the examples depicted in FIGS. 2B and 2C illustrate weight tensor sparsity patterns of blocks of 1×2 (e.g., consecutive sequential elements of the original weight tensor), it should be noted that these techniques can be extended to any desired block size.

Given a model with sparsity pattern of block of 1×2 (i.e., if both X[2i] and X[2i+1] are zero-valued elements in the uncompressed weight tensor, the block of {X[2i], X[2i+1]} may be considered sparse, otherwise a block with one or more non-zero-valued elements may be considered non-sparse). Sparsity conforming to the desired pattern (e.g., 1×2 sparse blocks) can be enforced while pruning the model, finetuning the model, and/or training the model. Using the enhanced packing scheme with 1×2 sparsity blocks, 1-bit may be used for every two values of the original weight tensor (i.e. X[2i] and X[2i+1]) in the compressed sparsity map 220 and therefore the compressed sparsity map 220's size is reduced by half (relative to the bit-wise sparsity map 218).

FIG. 2C depicts an edge case of using the enhanced packing scheme of FIG. 2B. In the example of FIG. 2C, the original weight tensor 222 includes alternating zero-valued elements and non-zero-valued elements. Accordingly, the original weight tensor 222 does not include any sparse blocks of size 1×2. As such, because each pair of elements in the original weight tensor 222 includes at least one non-zero-valued element, the compressed sparsity map 230 includes all 1-bit values. During unpacking, a 1-bit value in the compressed sparsity map 230 causes 2 elements to be read from SRAM (e.g., from left-to-right in the original tensor 222) resulting in a compressed tensor 234 that is actually larger than a compressed tensor 232 compressed using conventional sparsity-based compression. Even still, the compressed sparsity map 230 is half the size of the bit-wise sparsity map 228. However, as previously described, this represents an edge case. Sparse blocks can be enforced during model pruning, finetuning, and/or training. Accordingly, the edge case represented in FIG. 2C is intended to show that the compression scheme is functional even in edge cases where no sparse blocks are present.

FIG. 3 depicts an unpacking example where an expanded sparsity map 320 is generated from the compressed sparsity map 220 of FIG. 2B, in accordance with various examples of the present disclosure.

During the unpacking, one or more of the NPUs 124, 126, 128, etc., may perform the following to generate the expanded sparsity map 320 from the compressed sparsity map 220:
1. Insert two zeros in the expanded sparsity map 320 when a 0 is seen in the compressed sparsity map 220. This step is in contrast to inserting a single 0 inserted for previous bit-wise sparsity map generation.
2. Read two values from the weight tensor in SRAM into the expanded sparsity map 320 when a 1 is seen in the compressed sparsity map 220 (compared to insertion of a single value using previous bit-wise sparsity map generation). For sub 8-bit representations, using a specialized hardware instruction can increase the unpacking speed further.

Note that the above example is associated with sparsity blocks of 1×2. However, as described in further detail below, the techniques may be extended to any desired dimensions of sparsity blocks. The unpacking will be more efficient if supported by special HW instructions. This can reduce overhead associated with sparsity map to reconstruct the original weight tensor 310 and then do the multiplication operation with the activation tensor 312 (i.e. A*W). Using the enhanced techniques described herein result in faster reconstruction of the original weight tensor W (e.g., original weight tensor 310). The sparsity map overhead may also be reduced by applying the sparsity map on the targeted activation tensor A to reduce the size of the activation tensor 312 (e.g., to only the required activation elements corresponding to the non-zero-valued elements of the weight tensor) to generate the compressed activation tensor 340 and then do the multiplication operation with the compressed weight tensor 330 (i.e. A_compressed*W_compressed) to get further benefits on the compute speed. In such cases, constructing A_compressed may be faster relative to previous approaches. Additionally, in some examples, activation tensor 312 elements that do not correspond to non-zero elements of the compressed weight tensor 330 may be forced to zero since such elements will not contribute to any downstream activation (according to the zero property of multiplication).

Note that a sparsity block size of 1×2 is well aligned for 4-bit weights as two weight elements can take one byte in storage. Therefore, the unpacking benefits is more. For 2-bit weights, a sparsity block size of 1×2 may be used and 4 weights may be stored into one byte. However, if we extend this idea to block of 1×4 (i.e. if all X[4i], X[4i+1], X[4i+2] and X[4i+3] are zero-valued elements, the block of {X[4i], X[4i+1], X[4i+2], X[2i+3]} may be considered sparse, otherwise the block is considered non-sparse), additional benefits in memory footprint may be achieved as the CMAP overhead will drop by 75% (instead of 50% drop by block of 1×2) as well as during unpacking.

The enhanced packing scheme can be extended to block of arbitrary (1xn) size (i.e. if all X[ni], X[ni+1], . . . , and X[ni+n−1] are zero-valued elements, the block of {X[ni], X[ni+1], . . . , X[ni+n−1]} may be considered sparse, otherwise the block may be considered non-sparse). Note that LLMs are memory-bound during the token generation phase. Therefore, reducing the memory footprint due to the CMAP overhead size reduction may speedup the inference time of LLMs during token generation phase. However, the various sparsity packing and unpacking techniques described herein may be extended to any model (not exclusive to LLMs) types.

### Dense-Dense/Dense-Sparse Matrix Compute Engine

After loading the compressed activation tensors and weight tensors into the on-device memory buffer(s) 140, either a dense-dense matrix compute engine 116 or a dense-sparse matrix compute engine 116 may be used. The dense-sparse matrix compute engine 116 may be employed in cases where the weight tensor is sparsed. In this case, dense-sparse matrix multiplication (SpMM) algorithms may be employed to gain efficiencies during computation. An example of such an algorithm is the Vision Transformer Acceleration via Dedicated Algorithm and Accelerator Co-Design (ViTCoD) when multiplying the compressed activation tensor X by the compressed sparsed weight matrix W.

An example compute flow for the compute engine 116 is described below:
1) Option 1 (No sparsity in the compressed weight tensor and one compute core): The dense-dense matrix compute may be performed.
2) Option 2 (Sparse compressed weight tensor and one compute core): The dense-sparse matrix compute may be performed. In this case, the weight tensor can be compressed using CMAP enabling a smaller data transfer to the buffers (e.g., reduced memory bandwidth).
3) Option 3 (No sparsity in the compressed weight tensor and multiple compute cores): The hardware may be designed such that all compute cores access the same DRAM (or other buffer) in order to enable higher compute rate via parallelism. In this case, the compressed weight tensors may be moved to the shared DRAM. Three example scenarios are described:
   a) Multi-token compute (for example in prompt processing, speculative decoding, etc.): In this case, each compute core may perform the compute of one activation channel (e.g., of one token).
   b) One-token compute (for example in token generation): In this case the activation tensor has only one channel. Then the compute of “compressed activation*compressed weigh tensors” can be divided between compute cores in different ways:
      i) Each core handles the compute of a subset of compressed weight values. For example, if there are two compute cores, the first core may perform “compressed activation*first half of compressed weight columns” and the second core may perform “compressed activation*second half of compressed weight columns.”
      ii) Each core handles the compute of a subset of activation tensors. For example, if there are two compute cores, the first core may perform “first half of compressed activation*first half of compressed weight rows” and the second core may perform “second half of compressed activation*second half of compressed weight rows.” Then, the results of the two cores may be aggregated together.
      iii) Combination of approaches i) and ii). For example, if there are four compute cores, the first core may perform “first half of compressed activation*top left quarter of compressed weight”, the second core may perform “second half of compressed activation*bottom left quarter of compressed weight rows”, the third core may perform “first half of compressed activation*top right quarter of compressed weight rows”, the fourth core may perform “second half of compressed activation*bottom right quarter of compressed weight rows.” Then, the results of the four cores may be appended and aggregated together.
      iv) There is no shared DRAM and each core has its own DRAM. In this example, each core may only move the subset of compressed weights that are required for the core. The compute may be similar to the above-described cases. Then, the results of all cores may be appended and aggregated as needed. In this case, each core uses much less data movement and the memory bandwidth for each core may be reduced to a fraction of memory bandwidth used during conventional approaches.
   c) Multi-token compute with each activation channel compute being performed by more than one core, similar to the previous (one-token compute) approach.
4) Option 4 (Sparse compressed weight tensor and multiple compute cores): This example combines options 2) and 3), where each core performs dense-sparse matrix compute (similar to option 2)).

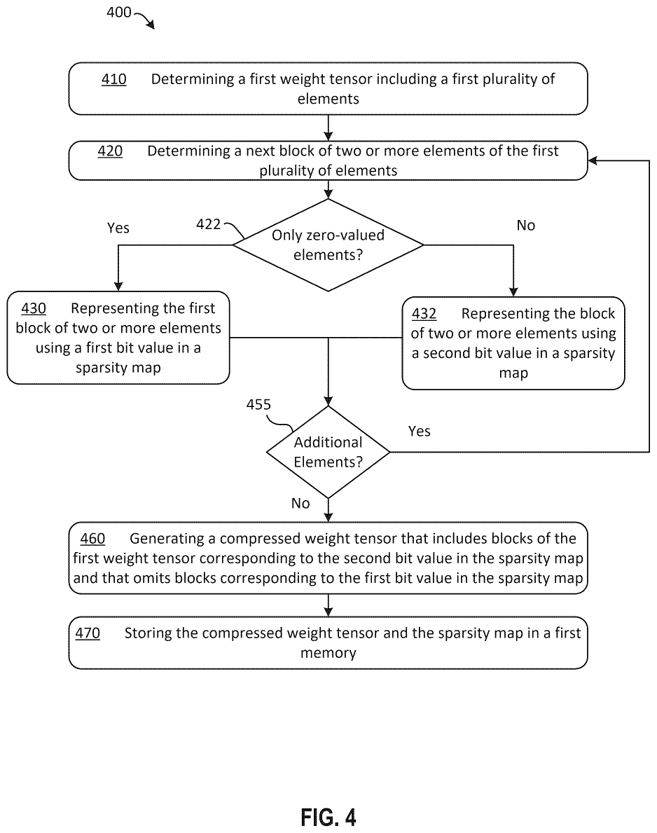

FIG. 4 depicts an example process 400 for sparsity packing for weight tensors of machine learning models, in accordance with various aspects of the present disclosure. The actions of the process 400 may represent a series of instructions comprising computer readable machine code executable by a processing unit of an image signal processor, although various operations may be implemented in hardware. In various examples, the computer readable machine codes may be comprised of instructions selected from a native instruction set of the processor(s) and/or an operating system of the computing device.

Process 400 may begin at action 410, at which at least one computing device (e.g., one or more computing devices 102) executing a machine learning model may determine a first weight tensor including a first plurality of elements. In various examples, the first weight tensor may be determined post-training (e.g., after training and/or fine tuning the machine learning model). As previously described, in some examples, during model training, pruning, and/or fine tuning, sparse blocks (meeting the desired block sparsity definition (e.g., 1×2, 1×3, 1×4, etc.)) may be enforced to increase the sparsity and/or to increase the compression achieved using the various techniques described herein.

Processing may continue at action 420, at which a next block of two or more elements of the first plurality of elements may be determined. During the first iteration, the “next” block may be the first block of elements of the first weight tensor. At action 422, the next block may be evaluated to determine whether the next block includes only zero-valued elements or, conversely, whether the next block includes one or more non-zero-valued elements. A block, in this context, refers to a predefined number of adjacent, consecutive elements of a given tensor (e.g., the first weight tensor). In various examples, if at action 422 a given block is determined to include only zero-valued elements, the block may be considered a sparse block.

Processing may continue at action 430, at which the sparse block of two or more elements may be represented using a first bit value in a sparsity map. For example, the block of two or more elements—a sparse block including only zero-valued elements—may be represented using a 0-bit (or a 1-bit, depending on the desired implementation) in a compressed sparsity map (such as compressed sparsity map 220 of FIG. 2B).

Conversely, if a block is determined at action 422 to include one or more non-zero-valued elements, processing may continue at action 432 at which the block of two or more elements may be represented using a second bit value in the sparsity map. For example, the block of two or more elements-a non-sparse block including at least one non-zero-valued element—may be represented using a 1-bit (or a 0-bit, depending on the desired implementation) in the compressed sparsity map. In any event, the non-sparse block may be represented using the opposite binary bit value as the sparse block.

Processing may continue to action 455. At action 455, a determination may be made of whether there are additional elements of the first weight tensor to be evaluated for generation of the compressed sparsity map. If so, processing may return to action 420 and the next block of two or more elements may be evaluated. Once all elements in the first weight tensor have been considered and the compressed sparsity map has been generated, processing may continue at action 460 at which a compressed weight tensor may be generated that includes the second block of two or more elements and omits the first block of two or more elements. For example, the zero-valued elements of the original weight tensor (e.g., the first weight tensor of action 410) may be omitted. It should be noted that the compressed weight tensor may be iteratively generated within the loop of FIG. 4 (instead of at the conclusion of the loop), depending on the desired implementation. For example, blocks consisting of only zero-valued elements (e.g., blocks represented by the first bit value in the compressed sparsity map) may be omitted from the compressed weight tensor and blocks with one or more non-zero-valued elements may be (e.g., blocks represented by the second bit value in the compressed sparsity map) represented in the compressed weight tensor. The recursive operations of FIG. 4 may continue until there are no more blocks of the first weight tensor to be evaluated. At that point, generation of the compressed weight tensor and the compressed sparsity map may be complete for the first weight tensor.

Processing may continue at action 470 at which the compressed weight tensor and the sparsity map (e.g., the compressed sparsity map) may be stored in a first memory. For example, the compressed weight tensor and the sparsity map may be stored in system memory and/or in SRAM until needed for compute (e.g., during inference processing of the relevant machine learning model). The compressed weight tensor and sparsity map result in the model having a smaller overall memory footprint.

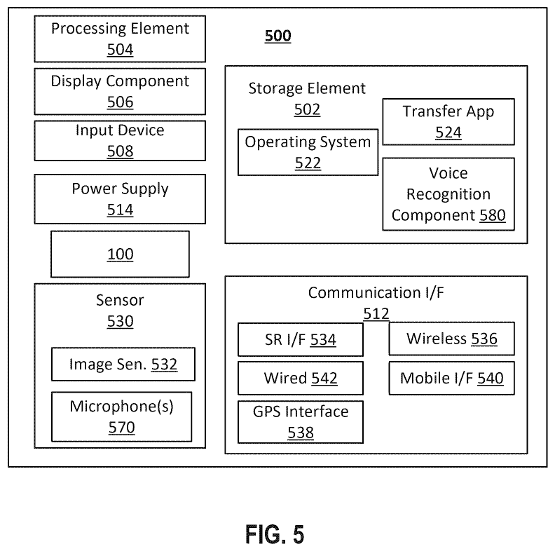

FIG. 5 is a block diagram showing an example architecture 500 of a network-connected device, such as a device that may include the machine learning accelerator 100. In various examples, it may be advantageous to deploy the machine learning accelerator 100 in network edge devices and/or resource constrained devices (such as a device including all or some portion of the components of architecture 500) as the machine learning accelerator 100 may lower computational requirements for model execution (e.g., for machine learning model inference).

It will be appreciated that not all devices will include all of the components of the architecture 500 and some user devices may include additional components not shown in the architecture 500. The architecture 500 may include one or more processing elements 504 for executing instructions and retrieving data stored in a storage element 502. The processing element 504 may comprise at least one processor. Any suitable processor or processors may be used. For example, the processing element 504 may comprise one or more digital signal processors (DSPs). In some examples, the processing element 504 may be effective to determine a wakeword and/or to stream audio data to a speech processing system. The storage element 502 can include one or more different types of memory, data storage, or computer-readable storage media devoted to different purposes within the architecture 500. For example, the storage element 502 may comprise flash memory, random-access memory, disk-based storage, etc. Different portions of the storage element 502, for example, may be used for program instructions for execution by the processing element 504, storage of images or other digital works, and/or a removable storage for transferring data to other devices, etc.

The storage element 502 may also store software for execution by the processing element 504. An operating system 522 may provide the user with an interface for operating the computing device and may facilitate communications and commands between applications executing on the architecture 500 and various hardware thereof. A transfer application 524 may be configured to receive images, audio, and/or video from another device (e.g., a mobile device, image capture device, and/or display device) or from an image sensor 532 and/or microphone 570 included in the architecture 500. In some examples, the transfer application 524 may also be configured to send the received voice requests to one or more voice recognition servers.

When implemented in some user devices, the architecture 500 may also comprise a display component 506. The display component 506 may comprise one or more light-emitting diodes (LEDs) or other suitable display lamps. Also, in some examples, the display component 506 may comprise, for example, one or more devices such as cathode ray tubes (CRTs), liquid-crystal display (LCD) screens, gas plasma-based flat panel displays, LCD projectors, raster projectors, infrared projectors or other types of display devices, etc. As described herein, display component 506 may be effective to display content determined provided by a skill executed by the processing element 504 and/or by another computing device. In some examples, the display component 506 and/or one or more speakers (not shown) may be effective to output an indication that unconsumed notifications (e.g., voice notifications) are pending. In some cases, there may be an indicator light effective to provide such an indication. In addition, speakers of the architecture 500 may output the voice notification audio upon receiving a user command to consume or “read” the voice notifications.

The architecture 500 may also include one or more input devices 508 operable to receive inputs from a user. The input devices 508 can include, for example, a push button, touch pad, touch screen, wheel, joystick, keyboard, mouse, trackball, keypad, light gun, game controller, or any other such device or element whereby a user can provide inputs to the architecture 500. These input devices 508 may be incorporated into the architecture 500 or operably coupled to the architecture 500 via wired or wireless interface. In some examples, architecture 500 may include a microphone 570 or an array of microphones for capturing sounds, such as voice requests. Voice recognition component 580 may interpret audio signals of sound captured by microphone 570. In some examples, voice recognition component 580 may listen for a “wakeword” to be received by microphone 570. Upon receipt of the wakeword, voice recognition component 580 may stream audio to a voice recognition server for analysis, such as a speech processing system. In various examples, voice recognition component 580 may stream audio to external computing devices via communication interface 512.

When the display component 506 includes a touch-sensitive display, the input devices 508 can include a touch sensor that operates in conjunction with the display component 506 to permit users to interact with the image displayed by the display component 506 using touch inputs (e.g., with a finger or stylus). The architecture 500 may also include a power supply 514, such as a wired alternating current (AC) converter, a rechargeable battery operable to be recharged through conventional plug-in approaches, or through other approaches such as capacitive or inductive charging.

The communication interface 512 may comprise one or more wired or wireless components operable to communicate with one or more other computing devices. For example, the communication interface 512 may comprise a wireless communication module 536 configured to communicate on a network, such as a computer communication network, according to any suitable wireless protocol, such as IEEE 802.11 or another suitable wireless local area network (WLAN) protocol. A short range interface 534 may be configured to communicate using one or more short range wireless protocols such as, for example, near field communications (NFC), Bluetooth, Bluetooth LE, etc. A mobile interface 540 may be configured to communicate utilizing a cellular or other mobile protocol. A Global Positioning System (GPS) interface 538 may be in communication with one or more earth-orbiting satellites or other suitable position-determining systems to identify a position of the architecture 500. A wired communication module 542 may be configured to communicate according to the USB protocol or any other suitable protocol.

The architecture 500 may also include one or more sensors 530 such as, for example, one or more position sensors, image sensors, and/or motion sensors. An image sensor 532 is shown in FIG. 5. An example of an image sensor 532 may be a camera configured to capture color information, image geometry information, and/or ambient light information.

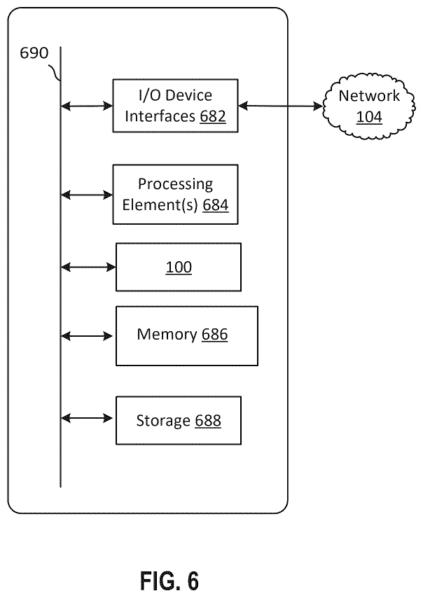

FIG. 6 is a block diagram conceptually illustrating example components of a computing device, such as the computing devices 102 and/or another computing device(s) implementing sparse activation-aware weight loading and inference for machine learning models, as described herein. In operation, each of these devices (or groups of devices) may include computer-readable and computer-executable instructions that reside on the respective device, as will be discussed further below.

Each computing device may include one or more controllers/processors 684, which may each include at least one central processing unit (CPU) for processing data and computer-readable instructions, and a memory 686 for storing data and instructions of the respective device. In at least some examples, memory 686 may store, for example, instructions effective to perform the various sparse activation-aware weight loading and inference described herein. In various further examples, memory 686 may be effective to store instructions effective to program controllers/processors 684 to perform the various techniques described above in reference to FIGS. 1-4. In addition, the machine learning accelerator 100 (including the sparsity-aware weight packing engine 150) may be instantiated in hardware in the system shown in FIG. 6. The memories 686 may individually include volatile random access memory (RAM), non-volatile read only memory (ROM), non-volatile magnetoresistive memory (MRAM), and/or other types of memory. Each device may also include a data storage component 688 for storing data and controller/processor-executable instructions. Each data storage component 688 may individually include one or more non-volatile storage types such as magnetic storage, optical storage, solid-state storage, etc. Each device may also be connected to removable or external non-volatile memory and/or storage (such as a removable memory card, memory key drive, networked storage, etc.) through respective input/output device interfaces 682. The architecture depicted in FIG. 6 may communicate with one or more other devices over network 104 (e.g., the Internet).

Computer instructions for operating each device and its various components may be executed by the respective device's controllers/processors 684, using the memory 686 as temporary “working” storage at runtime. A device's computer instructions may be stored in a non-transitory manner in non-volatile memory 686 (e.g., a non-transitory computer-readable memory), data storage component 688, or an external device(s). Alternatively, some or all of the executable instructions may be embedded in hardware or firmware on the respective device in addition to or instead of software.

Each device may include input/output device interfaces 682. A variety of components may be connected through the input/output device interfaces 682, as will be discussed further below. Additionally, each device may include an address/data bus 690 for conveying data among components of the respective device. Each component within a device may also be directly connected to other components in addition to (or instead of) being connected to other components across the bus 690.

Although various systems described herein may be embodied in software or code executed by general purpose hardware as discussed above, as an alternate the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon applying one or more data signals, application specific integrated circuits having appropriate logic gates, or other components, etc. Such technologies are generally well known by those of ordinary skill in the art and consequently, are not described in detail herein.

As used herein (e.g., including in the claims of the application), the terms “first”, “second”, and so forth, do not necessarily imply a particular order of events or elements, but are used to distinguish individual elements from one another. For example, the language a “first layer” of a machine learning model does not necessarily mean that the layer is the initial layer of the model. Instead, the adjective “first” may merely be intended to distinguish the layer from other layers such as a “second” layer. In fact, in various examples, the second layer may precede the first layer and there may be any number of intervening layers between the “first layer” and the “second layer.”

The flowcharts and methods described herein show the functionality and operation of various implementations. If embodied in software, each block or step may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s).

Although the flowcharts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be skipped or omitted. It is understood that all such variations are within the scope of the present disclosure.

Also, any logic or other type of application described herein that comprises software or code can be embodied in any non-transitory computer-readable medium or memory for use by or in connection with an instruction execution system such as a processing component in a computer system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as magnetic, optical, or semiconductor media. More specific examples of a suitable computer-readable media include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

What is claimed is:

1. A system comprising:
a neural network accelerator apparatus comprising:
one or more processors; and
one or more computer readable media storing processor executable instructions which, when executed using the one or more processors, perform operations comprising:
using first tensor data representing a first weight tensor comprising a first plurality of elements, determining that a first block of two consecutive elements of the first plurality of elements consists of zero-valued elements;
storing first sparsity data indicating that the first block of two consecutive elements consists of zero-valued elements using a 0-bit in a sparsity map;
determining a second block of two or more consecutive elements of the first plurality of elements, wherein the second block comprises at least one non-zero element;
representing the second block of two or more consecutive elements using a 1-bit in the sparsity map;
generating a compressed weight tensor that comprises the second block of two or more consecutive elements and omits the first block of two or more consecutive elements; and
storing the compressed weight tensor and the sparsity map in a first memory.

2. The system of claim 1, wherein the one or more computer readable media store further processor executable instructions which, when executed using the one or more processors, perform further operations comprising:
determining that a compute operation associated with a first layer of a neural network uses the first weight tensor; and
loading the compressed weight tensor and the sparsity map from the first memory into static random access memory (SRAM).

3. The system of claim 2, wherein the one or more computer readable media store further processor executable instructions which, when executed using the one or more processors, perform further operations comprising:
reading the 0-bit from the sparsity map;
in response to reading the 0-bit from the sparsity map, generating an expanded sparsity map by inserting two or more zero values in a data structure having a same dimensionality as the first weight tensor;
reading the 1-bit from the sparsity map; and
in response to reading the 1-bit from the sparsity map, updating the expanded sparsity map by reading two or more values from the compressed weight tensor.

4. The system of claim 3, wherein the one or more computer readable media store further processor executable instructions which, when executed using the one or more processors, perform further operations comprising:
determining, for a first non-zero element of the compressed weight tensor, a first corresponding element of an activation tensor using the expanded sparsity map, wherein the activation tensor is an input to the first layer of the neural network.

5. A system comprising:
a neural network accelerator apparatus comprising:
one or more processors; and
one or more computer readable media storing processor executable instructions which, when executed using the one or more processors, perform operations comprising:
based on first tensor data representing a first weight tensor comprising a first plurality of elements, determining that a first block of two or more elements of the first plurality of elements consists of zero-valued elements;
based on the determining that the first block consists of zero-valued elements, storing, as part of first sparsity data representing a sparsity map, a first bit value indicating that the first block consists of zero-valued elements;
based on first tensor data representing a first weight tensor comprising a first plurality of elements, determining that a second block of two or more elements of the first plurality of elements comprises a non-zero element;
based on the determining that the second block comprises a non-zero element,
storing, as part of weight data representing a compressed version of the first weight tensor, values of the second block, and
storing, as part of the first sparsity data, a second bit value indicating that the second block comprises a non-zero element.

6. The system of claim 5, wherein a first element of the first weight tensor comprises a 4-bit weight value.

7. The system of claim 5, wherein the one or more computer readable media store processor executable instructions which, when executed using the one or more processors, perform operations comprising:
determining that a compute operation associated with a first layer of a neural network uses the first weight tensor; and
loading the weight data representing the compressed version of the first weight tensor and the first sparsity data representing a sparsity map from the first memory into static random access memory (SRAM).

8. The system of claim 7, wherein the one or more computer readable media store processor executable instructions which, when executed using the one or more processors, perform operations comprising:
determining that a first bit of the first sparsity data corresponds to the first bit value;
based on the determining that the first bit of the first sparsity data corresponds to the first bit value, inserting two or more zero values in decompressed weight data representing a decompressed version of the first weight tensor;
determining that a second bit of the first sparsity data corresponds to the second bit value;
based on the determining that the second bit of the first sparsity data corresponds to the second bit value,
reading a set of two or more values from the weight data, and
adding the set of two or more values to the decompressed weight data.

9. The system of claim 8, wherein the one or more computer readable media store processor executable instructions which, when executed using the one or more processors, perform operations comprising:
performing a first operation utilizing the decompressed weight data and activation data representing an activation tensor.

10. The system of claim 5, wherein the one or more computer readable media store processor executable instructions which, when executed using the one or more processors, perform operations comprising:
generating, using the first sparsity data and activation data representing a first activation tensor, compressed activation data representing a compressed version of the first activation tensor;
performing a first operation utilizing the compressed activation data and the weight data.

11. The system of claim 5, wherein the system comprises an electronic device comprising a central processor, a camera, a microphone, a speaker, and wherein the electronic device comprises the neural network accelerator apparatus.

12. The system of claim 5, wherein each element of the sparsity map is associated with two elements of the first weight tensor.

13. A method comprising:
determining a first weight tensor comprising a first plurality of elements;
determining a first block of two or more elements of the first plurality of elements, wherein the first block consists of zero-valued elements;
representing the first block of two or more elements using a first bit value in a sparsity map;
determining a second block of two or more elements of the first plurality of elements, wherein the second block comprises at least one non-zero element;
representing the second block of two or more elements using a second bit value in the sparsity map;
generating a compressed weight tensor that comprises the second block of two or more elements and omits the first block of two or more elements; and
storing the compressed weight tensor and the sparsity map in a first memory.

14. The method of claim 13, wherein a first element of the compressed weight tensor comprises a 4-bit weight value.

15. The method of claim 13, comprising:
determining that a compute operation associated with a first layer of a neural network uses the first weight tensor; and
loading the compressed weight tensor and the sparsity map from the first memory into static random access memory (SRAM).

16. The method of claim 15, comprising:
reading the first bit value from the sparsity map;
in response to reading the first bit value from the sparsity map, generating an expanded sparsity map by inserting two or more zero values in a data structure having a same dimensionality as the first weight tensor;
reading the second bit value from the sparsity map; and
in response to reading the second bit value from the sparsity map, updating the expanded sparsity map based on reading two or more values from the compressed weight tensor.

17. The method of claim 16, comprising determining, for a first non-zero element of the compressed weight tensor, a first corresponding element of an activation tensor using the expanded sparsity map, wherein the activation tensor is an input to the first layer of the neural network.

18. The method of claim 17, wherein the first corresponding element of the activation tensor is identified as corresponding to an element of the expanded sparsity map with the second bit value.

19. The method of claim 13, wherein training a neural network comprising a first layer associated with the first weight tensor comprises causing learning pairs of consecutive zero-valued weight tensor elements.

20. The method of claim 13, wherein each element of the sparsity map is associated with two elements of the first weight tensor.
